(19) United States
(12) Patent Application Publication
(10) Pub. No.: US 2002/0059190 A1
(43) Pub. Date: May 16, 2002

(54) Registration and search system for obtaining information on facilities

(76) Inventor: Mitsuru Ishizaki, Obu-city (JP)

Correspondence Address: LAW OFFICE OF DAVID G POSZ, 2000 L STREET, N.W., SUITE 200, WASHINGTON, DC, 20036, US

(21) Appl. No.: 09/833,633

(22) Filed: Apr. 13, 2001

(30) Foreign Application Priority Data
Apr. 14, 2000 (JP) 2000-113553

(51) Int. Cl. G06F 7/00

(52) U.S. Cl. 707/2

(57) ABSTRACT

A registration template in which registration headings are stated and a search template in which search headings matching the registration headings are stored in a template storage of a management center. At a registration terminal, based on the registration template transmitted from the management center, information providers are prompted to enter facility information. The entered facility information is stored in a facility information storage of the management center. In a car navigation system, based on the search template transmitted from the management center, a user is urged to enter sought information. The management center searches facility information by using this sought information, and the search result is provided to the user at the car navigation system.

### CROSS-REFERENCE TO RELATED APPLICATION

The present invention is related to Japanese patent application No. Hei. 2000-113553, filed Apr. 14, 2000; the contents of which are incorporated herein by reference.

### FIELD OF THE INVENTION

The present invention relates to registration and search of facility information, and more particularly, to registration and search of facility information in a more efficient and effective manner.

### BACKGROUND OF THE INVENTION

In recent years, search of facility information on a network by organizing information on various facilities into a database has become possible. Such facilities include gas stations and other items located along a vehicle rout that a vehicle driver requires to determine whether to stop at a respective facility. Such systems must enable information providers to readily register facility information and enable users to search for information meeting their respective needs.

In connection with this, various proposals have been made for ways to register and/or search facility information. For instance, Japanese Patent No. 2956587 discloses a method by which advertised information (facility information) is registered by relevance to map data by displaying a map and designating its location on that map. JP-A No. H10-89976, for example, discloses an apparatus for searching facility information, where it is assumed that the facility information relates to a map, by designating the type of facility and the range of maps to be searched. All embodiments of the prior art, typified by these examples, are intended to display facility information in a two-dimensional span by linking locational facility information with maps, and simplify both levels of registration by information providers and search by users in the position of a pertinent facility.

However, there are situations in which no prior art technique allows retrieval of information meeting the need of the searching user. This is mainly because the key category of facility information is map location. According to the Japanese Patent No. 2956587, for instance, as a user selects an icon on a map, i.e. designates locational information, the remaining items of information are provided. The JP-A No. H10-89976, as described above, enables facility information to be searched based on the type of facility and the geographical distance involved.

Thus, none of prior art techniques permits search by a minor category of information, which could be regarded as incidental. More specifically, it is impossible to search restaurants according to the availability of parking space or supermarkets according to what the loss leader is. By any conventional technique, such items of information are made available only after a facility is specified. Therefore, if a user searches for restaurants within a 1 km radius of a given point and finds 10 restaurants in the area, the search may end up with a finding that none of the 10 restaurants has a parking lot.

The present invention enables facility information to be registered or searched according to miscellaneous items of information (incidental information).

### SUMMARY OF THE INVENTION

In a first aspect, a registrable information input unit of a registration terminal accepts facility information input from an information provider according to a registration template. The registration template provides predetermined registration headings, and items of information under these registration headings constitute facility information. This facility information is transmitted by a registrable facility information transmitter to a management center, and stored into a facility information storage unit of the management center.

At a search terminal, a sought information input unit allows user to enter search conditions according to a search template. The search template provides predetermined search headings matching the registration headings, and items of information under these search headings constitute sought information. This arrangement allows facility information searching according to registration headings. This sought information is transmitted by a sought information transmitter to the management center.

At the management center, a search unit, using the transmitted sought information, searches facility information stored in the facility information storage unit. Then, a sought facility information transmitter transmits facility information search results to the search terminal, and a notifying unit of the search terminal notifies the facility information that the search result is transmitted from the management center.

The present invention uses a registration template to limit differences in entered categories of facility information from one registering information provider to another, and to have sufficient but not excessive facility information, including incidental information, entered to facilitate subsequent search. Since information providers have only to fill blanks under registration headings, registration of facility information is much simpler. On the other hand, a search template is used to enable information matching the registration headings to be entered as sought information. Users have only to enter sought information by filling blanks under search headings and, as facility information is searched according to the sought information entered in this way, search facility information is also facilitated. Since search headings matching the registration headings are stated in the search template, search according to a category of incidental information is also made possible.

If the type of searched facility changes, the search conditions also change. According to another aspect, the registration headings and the search headings are set according to the facility type, allowing search of information according to more finely classified incidental information. Registration and search templates may be stored at the registration terminal and the search terminal in advance. It is best, however, to transmit them from the management center. Thus, if the variety of facility types increases, the increase can be addressed by having a registration or search template matching the increased variety transmitted by the management center.

There may also be items of information the pertinent facility wishes to emphasize. Therefore, search headings matching registration headings mean search headings those registration headings that can be search keys. Preferably, not all items must be entered. For instance, where the locations, open hours and prices of facilities are stated as search headings, searching can be performed according to only the location, open hours, price or a combination of any two of these items. facilities can also be searched according to only one item of information or narrowed to a plurality of items. The effectiveness of the search can be enhanced by utilizing incidental information as well.

Preferably, information providers who supply facility information can determine whether information provided meets user's search conditions. Accordingly, the number of successful search attempts (number of hits) is stored into a search frequency storage unit of the management center for each unit of facility information. Therefore, if this number is made known to information providers, it provides a measure of need for updating facility information. Specifically, if the number of hits is too small, the information provider concerned can update the information contents to more effective ones. If useful information increases as a result, users will more frequently access this system.

In another aspect, the number of times facility information is utilized (frequency of utilization) is stored in a utilization frequency storage unit at the management center for each unit of facility information. This information is provided to information providers as the number of hits. Accordingly, when a unit of facility information is utilized, the search terminal notifies the utilized unit of facility information to the management center. Conceivably, determination as to whether a given unit of facility information has been utilized is made, where for instance the configuration is such that only the name of a facility is first displayed on a display unit or the like as facility information retrieved by search, according to whether that facility name has been selected by an operation by an user and any other unit of facility information has been referenced.

To allow information providers to use the system to promote the use of particular facilities, i.e. for advertising or promotions, in storing a particular unit of facility information from the registration terminal, the management center calculates the registration fee for that unit of information. By using the revenue of such registration fees to pay the operating system maintenance costs or the cost to users for communicating with the management center, it will provide added revenue or user advantage.

In another aspect, the registration fee is discounted based on the number of hits or frequency of utilization or both. This provides incentive to information providers to provide more of useful facility information and enhance the number of hits and/or the frequency of utilization, and eventually contribute to expanding the utilization of the system.

In another aspect, while the search terminal can be a desktop unit, it can have a mobile configuration embodied in a laptop or handheld unit. Accordingly, locational information can be displayed as an item of facility information such as an icon or the like on a map shown on the display unit of the search terminal.

In another aspect, the registration procedure for locational information is simplified and, moreover, at least locational information as an item of facility information is associated with map data. This locational information can be readily displayed on a map at the search terminal as well. It is also conceivable to transmit the map data from the management center to be displayed at the time registration because, unlike at the search terminal, it is sufficient at the registration terminal to display on a map covering the vicinity of the pertinent registered facility. When updating facility information, too, the information to be updated can be readily selected if map data associated with the location of the facility are transmitted from the management center.

The search terminal can be a mobile unit in a car navigation system having a route guidance function. In this case, the search terminal functioning as a car navigation system may have a configuration in which the current location, destination, points en route and guided route among other items are transmitted to the management center as sought information or as part of sought information. Then, the management center search unit searches its store of facility information with the current location, destination, points en route and guided route as keys to the search. This would further facilitate searching of facility information and expand the variety of available searching techniques. For this configuration, sought information may as well be given in the form of a search coverage which is expressed as an xxx km radius of a prescribed geographical points, such as the current location, or a guided route. In this case, of course, the search unit at the management center would search the set coverage of search.

Further, the search terminal functioning as a car navigation system may be enabled to set the destination or points en route based on facility information transmitted from the management center as a search finding.

The search terminal determines whether retrieved facility information has been utilized and, if it has been, transmits that facility information to the management center, which then stores the frequency of utilization as described above. With this configuration, the search terminal can act as a navigation system allowing determination that, if a destination or points en route have been set based on a particular unit of facility information, that particular unit of facility information has been utilized.

Whereas the foregoing description referred to the invention as one of a facility information registration/search system, the invention can as well be implemented as a management center, as one registration terminal, or as one search terminal.

Further areas of applicability of the present invention will become apparent from the detailed description provided hereinafter. It should be understood that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a block diagram illustrating a schematic configuration of a registration/search system according to the present invention;

FIG. 2 is a block diagram illustrating a schematic configuration of a car navigation system according to the present invention;

FIG. 3 is a flow chart of a registration request executed at the registration terminal according to the invention;

FIG. 4 is a registration flow chart executed at the management center according to the invention;

FIG. 5 is a flow chart of a search request executed at the car navigation system according to the invention;

FIG. 6 is a flow chart of search executed at the management center according to the invention;

FIG. 7A is an explanatory diagram showing an example each of registration template and search template according to the invention;

FIG. 7B is an explanatory diagram showing an example each of registration template and search template according to the invention;

FIG. 8A is an explanatory diagram showing an example of sequence of display screens on the car navigation system according to the invention;

FIG. 8B is an explanatory diagram showing an example of sequence of display screens on the car navigation system according to the invention;

FIG. 8C is an explanatory diagram showing an example of sequence of display screens on the car navigation system according to the invention;

FIG. 9A is an explanatory diagram showing an example display sequence on the car navigation system according to the invention;

FIG. 9B is an explanatory diagram showing an example display sequence on the car navigation system according to the invention;

FIG. 10 is a flow chart of issuing an invoice at the management center according to the invention;

### DETAILED DESCRIPTION OF THE PREFERRED EMBODIMENTS

A preferred embodiment of the present invention will be described below with reference to drawings.

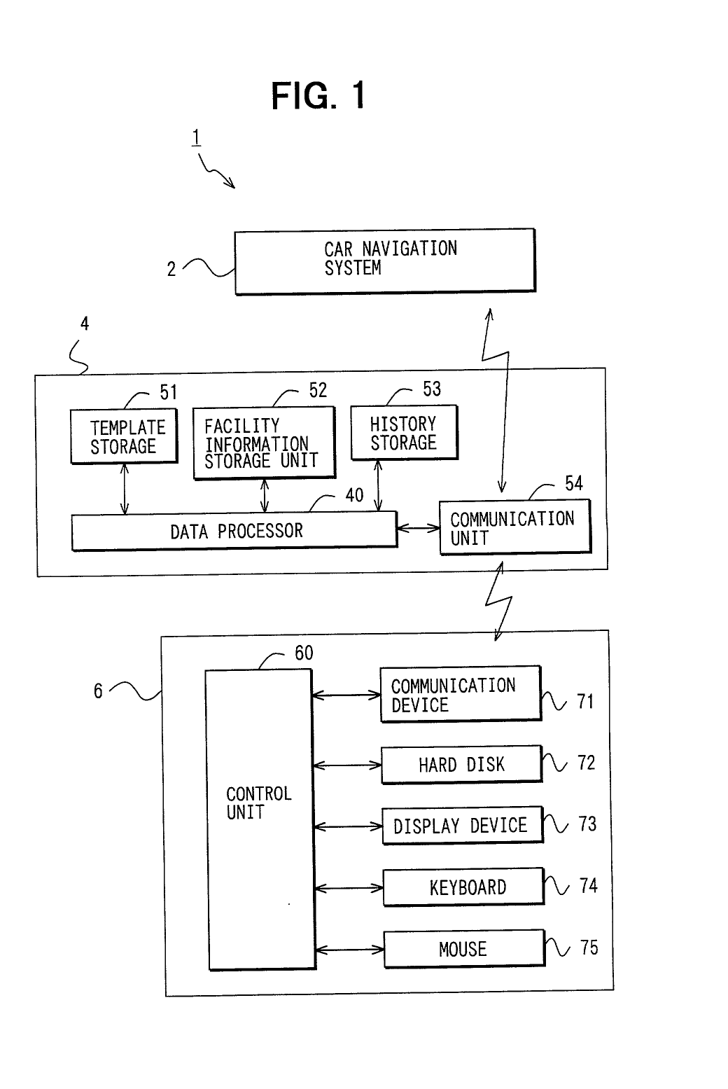

FIG. 1 is a block diagram illustrating a schematic configuration of a registration/search system 1 embodying the present invention. The registration/search system 1 has a car navigation system 2 as a search terminal, a management center 4 as a management center, and a registration terminal 6 as a registration terminal. The management center 4 is provided with a data processor 40, a template storage 51 connected to the data processor 40, a facility information storage 52, a history storage 53 and a communication unit 54.

The data processor 40 is what is commonly called a computer system, having a CPU, ROM, RAM, I/O unit and so forth, and takes charge of overall control of the management center 4. The template storage 51, the facility information storage 52 and the history storage 53 are the hard disks. In the template storage 51, registration and search templates are stored that differ from one facility type to another. In the facility information storage 52, facility information is stored that was supplied by information providers. In the history storage 53, the number of hits are stored and the frequency of utilization, to be described later, for each unit of facility information. The communication unit 54 is intended for data communication between the car navigation system 2 and the registration terminal 6. Data communication between the car navigation system 2 and the registration terminal 6 is preferably accomplished over a telephone line.

The registration terminal 6 is provided with a control unit 60, a communication device 71, a hard disk 72, a display device 73, a keyboard 74 and a mouse 75. The control unit 60 here has a CPU, ROM, RAM, I/O device and so forth, and the registration terminal 6 has a similar configuration to that of a personal computer. Therefore, the communication device 71 can be used as a modem. The display device is realized as a display apparatus using a CRT or liquid crystals.

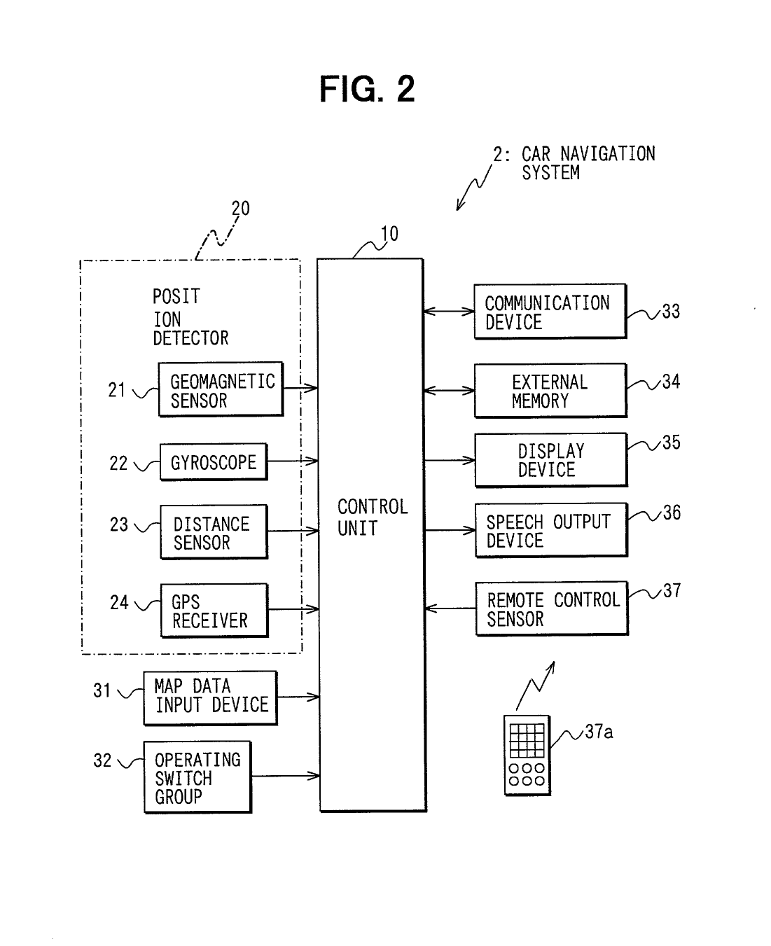

The car navigation system 2, as illustrated in FIG. 2, has a configuration centering on the control unit 10. To control unit 10 are connected a position detector 20, a map data input device 31, an operating switch group 32, a communication device 33, an external memory 34, a display device 35, a speech output device 36 and a remote control sensor 37. The control unit 10 is configured as an ordinary computer, provided with a CPU, ROM, RAM, I/O device and a bus line connecting these constituent elements.

The position detector 20 has a geomagnetic sensor 21, a gyroscope 22, a distance sensor 23 and a GPS receiver 24 for a GPS (Global Positioning System) to detect the position of the car based on electric waves from satellites, all of which are well known devices. This configuration having a plurality of sensors 21 through 24 complement one another as they are subject to errors differing in character. Depending on their levels of precision, some of the above-described sensors may suffice, or a rotation sensor for steering or a wheel sensor for each rolling wheel may be used instead.

The map data input device 31 is for entering map matching data, intended to enhance the accuracy of position detection, and map data. This data is entered from a DVD serving as a recording medium. Although a DVD is used in this embodiment, a CD-ROM, a memory card or other appropriate medium may be used in place of the DVD.

The operating switch group 32 consists of touch switches or mechanical switches integrated with the display device 35, and are used for various input purposes. The communication device 33 functions when a so-called handy phone is connected to it, and data communication with the management center 4 takes place via this communication device 33.

The external memory 34 is a hard disk for storing necessary information for executing various processes. However, since the only function needed here is to store information, a different device, e.g. a semiconductor memory device may be used. The display device 35 is a color LCD or a CRT display device. Information is provided to a user from the car navigation system 2 via this display device 35. The speech output device 36, provided with a loudspeaker system (not shown), is for orally broadcasting from the system side route guidance or an input request. The remote control sensor 37 acquires operational information from the user via a remote control 37a. This configuration realizes the so-called navigator function. On the screen of the display device 35 is displayed, overlapping with each other, a car's current location mark entered from the position detector 20, map data entered from the map data input device 31, and additional data displayed on the map including the guided route, name, distinguishing mark and so on. With car navigation system 2, when the location of the destination and, as required, designation of a specific route including an expressway (i.e. designation points en route) are entered from the remote control sensor 37 via the remote control terminal 37a and from the operating switch group 32, the optimal route from the current location to the destination is automatically selected to form and display a so-called guided route. As such, techniques for automatically setting the optimal route, the Dijkstra method and others are known. After this guided route is formed and displayed, route guidance is provided from the control unit 10 via the speech output device 36 according to the running condition of the car.

Furthermore, the car navigation system 2 in this embodiment can make a facility information search request with the management center 4, and reference, or utilize for the navigator function, facility information as the search result transmitted from the management center 4. Next, the operation of the registration/search system 1 embodying the invention will be described.

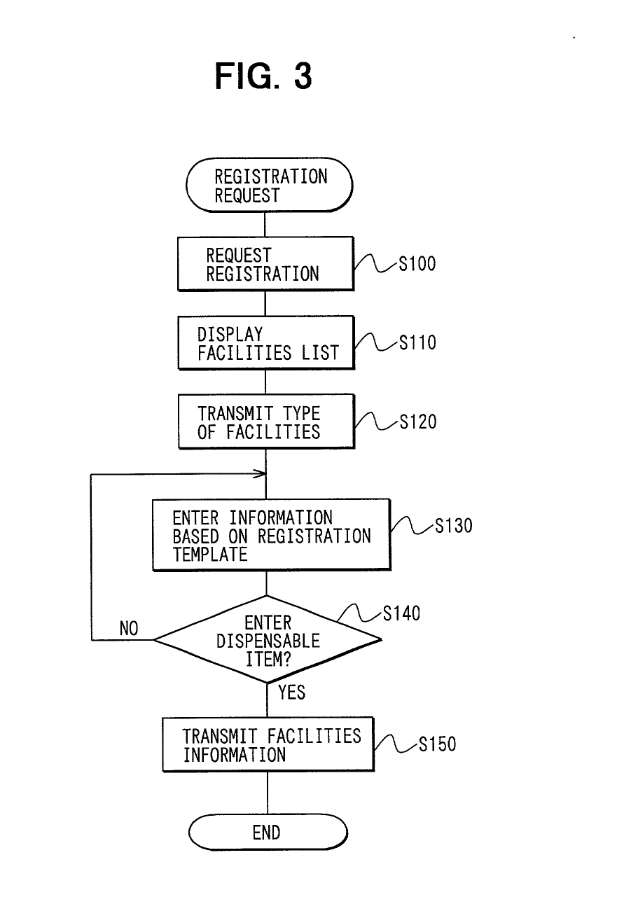

First, facility information registration that takes place between the registration terminal 6 and the management center 4 is described. Here, processing of a request for registration executed by the control unit 60 of the registration terminal 6 is described with reference to the flow chart of FIG. 3. This processing is executed when a data communication enable state is established between the registration terminal 6 and the management center 4 as a call is initiated by the registration terminal upon the management center 4.

At the first step (hereinafter abbreviated to S) 100, a facility information registration request is made with the management center 4. In response to this registration request, a facilities list indicating the facility types are transmitted from the management center 4. The facility types include, e.g. service stations, supermarkets, banks, hospitals, parking lots and amusement parks.

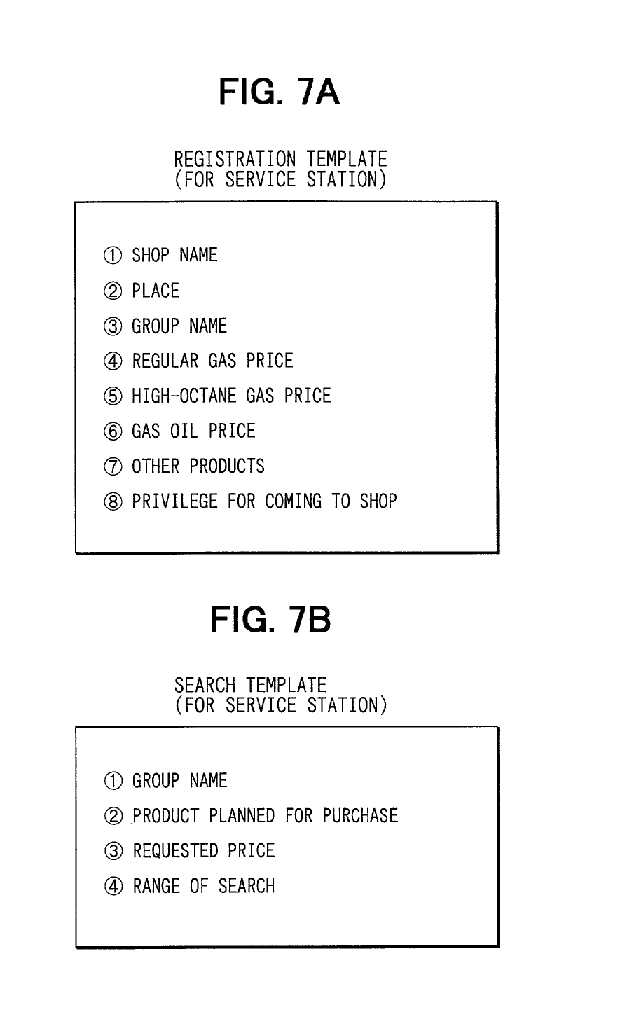

At S110 that follows, the display device 73 displays the facilities list indicating the facility types, and urges the communicating information provider to select a facility type. The information provider selects the facility type desired for registration via the keyboard 74 and the mouse 75. Then, at S120, the selected facilities is transmitted to the management center 4. Once the facility type is transmitted in this way, the management center 4, with its data processor 40, reads a registration template for registering a facility of the selected type out of the template storage 51 and transmits it. This registration template differs from one facility type to another, and contains registration headings matching the facility type. To cite a specific example of the registration template, a registration template for registering information on a service station, for instance, has such registration headings as those listed in FIG. 7A. Here are eight registration headings comprising 1) station name, 2) location, 3) group name (indicating what oil company the station is affiliated with), 4) price of gasoline (regular), 5) price of gasoline (premium), 6) price of light oil, 7) other products sold and 8) incentive to customers. The heading “other products sold” is included because some service stations sell food items such as rice and/or sweets.

At S130, based on the registration template, the information provider is required enter information under each registration heading. Information to come under “2) location” is entered by having the provider point with the mouse 75 to the pertinent location on a map displayed on the display device 73. This associates the locational information with map data. The map data for displaying a map are transmitted from the management center 4. Information to come under “8) incentive to customers” may be, conceivably, free toilet paper rolls or free check-up of the car.

Then, at S140 that follows, it is determined whether indispensable items of information have been entered to ensure that sufficient but not excessive information that can serve as search keys has been entered. For instance, in the registration template for service stations shown in FIG. 7A, conceivably the first through seventh items can be designated to be indispensable. If all the indispensable items are found entered (S140: YES), the items of facility information entered under the registration headings are transmitted to the management center 4 at S150, and the processing of this registration request is completed after that. If any of the indispensable item is left out (S140: NO), processing from S130 is repeated.

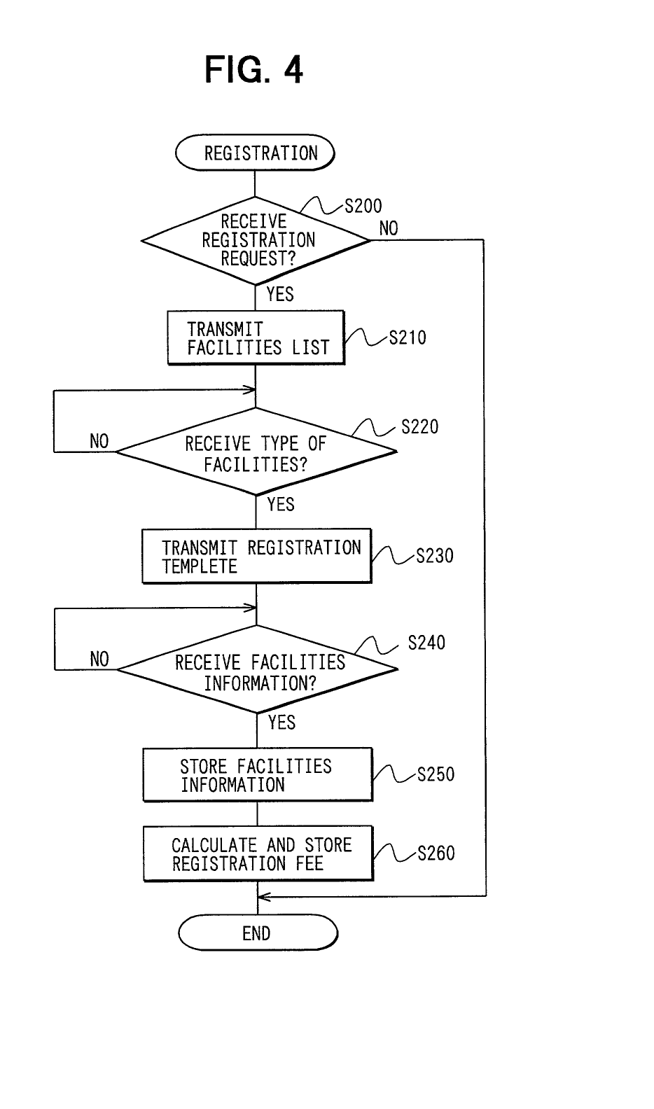

Registration processing machine this registration request processing is executed by the data processor 40 or the management center 4. Now this registration processing will be described with reference to the flow chart of FIG. 4. This registration processing is repeatedly executed once a data communication enable state is established between the registration terminal 6 and the management center 4.

First at S200, it is determined whether a registration request has been received from the registration terminal 6. This processing matches the registration request at step 100 in FIG. 3, and the determination is affirmative if a registration request was made at S100. If it is determined here that a registration request has been received (S200: YES), the process will move ahead to S210. If there has been no registration request (S200: NO), this registration processing is ended.

At S210, a facilities list indicating the facility types is transmitted. In response, the registration terminal 6 displays the facilities list as stated above (S110 in FIG. 3), and transmits the selected facility type (S120). Therefore, at the following S220, it is determined whether the selected facility type has been received. If the facility type has not been received here (S220: NO), this determination processing is repeated. If the facility type has been received (S220: YES), the process goes to S230.

At S230, according to the received facility type, a registration template is transmitted. This causes the registration terminal 6 to transmit facility information to be entered according to this registration template (S150 in FIG. 3). Therefore, at the next S240, it is determined whether facility information has been received. If facility information has not been received here (S240: NO), this determination processing is repeated. If facility information has been received (S240: YES), the process goes ahead to S250.

At S250, the facility information is stored into the facility information storage 52. At s260 that follows, the registration fee is calculated and stored. After that, this registration processing is completed.

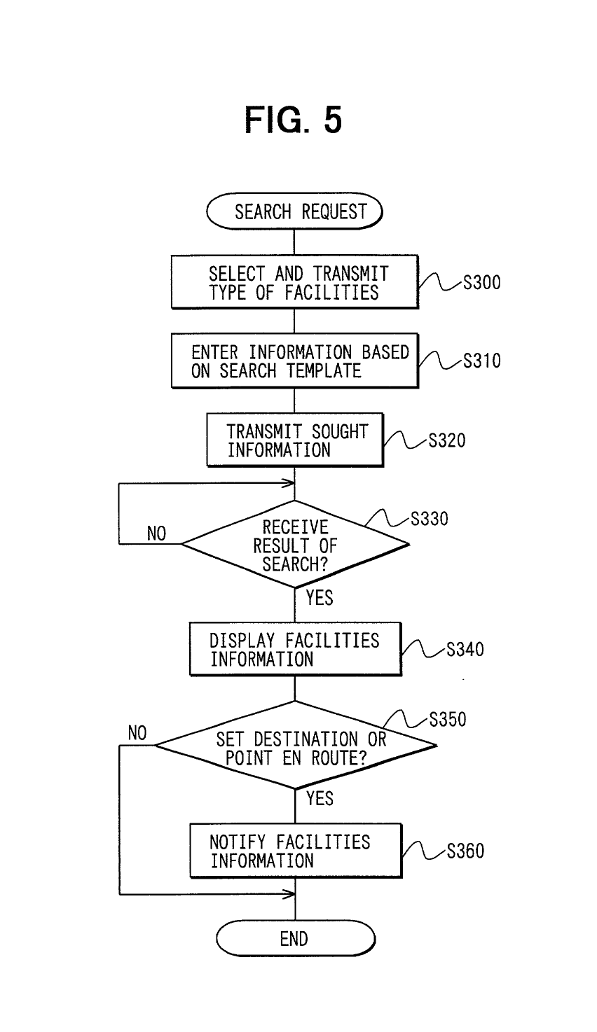

Next, the search facility information operation that takes place between the car navigation system 2 and the management center 4 is described. The control unit 10 of the car navigation system 2, when the operating switch group 32 or the remote control terminal 37a via the remote control sensor 37 provides an input, calls the management center 4 and, awaiting the establishment of a data communication enable state with the management center 4, executes search request processing. This search request processing will is described with reference to the flow chart of FIG. 5.

First at S300, the user in the car is prompted to select a facility type and, upon selection by the user of a facility type to be searched. The selected facility type is transmitted to the management center 4. This type of facility is that registered with the management center 4, and is to be included in the facilities list transmitted at S210 in FIG. 4 by the management center 4 to the registration terminal 6. It can be, for instance, service stations, supermarkets, banks, hospitals, parking lots or amusement parks. As the facility type is transmitted, the management center 4 transmits a search template. This search template matches the registration template, in which search headings matching the registration headings are provided. As an example, a search temperate for searching information on a service station has such registration headings as those listed in FIG. 7B. Here are a number of registration headings comprising 1) group name, 2) product planned for purchase, 3) desired price and 4) range of search.

At the next S310, the user is required to enter sought information based on the search template. Information need not be entered under all the search headings. Then at the following S320, the sought information is transmitted to the management center 4. In response, the management center 4 transmits facility information as the search result.

Therefore, at the next S330, it is determined whether any search result has been received. If no search result has been received here (S330: NO), the determination processing is repeated. If any search result has been received (S330: YES), the facility information of the search result is displayed on the display device 35 at S340. In this embodiment, displayed facility information permits selection by operating the operating switch group 32 by the user, which can display detailed information on the located facility or display its location on the map. Route guidance can be initiated with the facility as the destination or a point en route.

At the next step S350, it is determined whether the identified facility has been set as either the destination or a point en route to determine whether the facility information has been utilized. If it is determined here that the facility has been set as either the destination or a point en route (S350: YES), that facility information is provided to the management center 4 at step S360, after this search request processing is completed. If it is determined that the facility has not been set as either the destination or a point en route (S350: NO), processing at S360 is not executed, and this search request processing is completed.

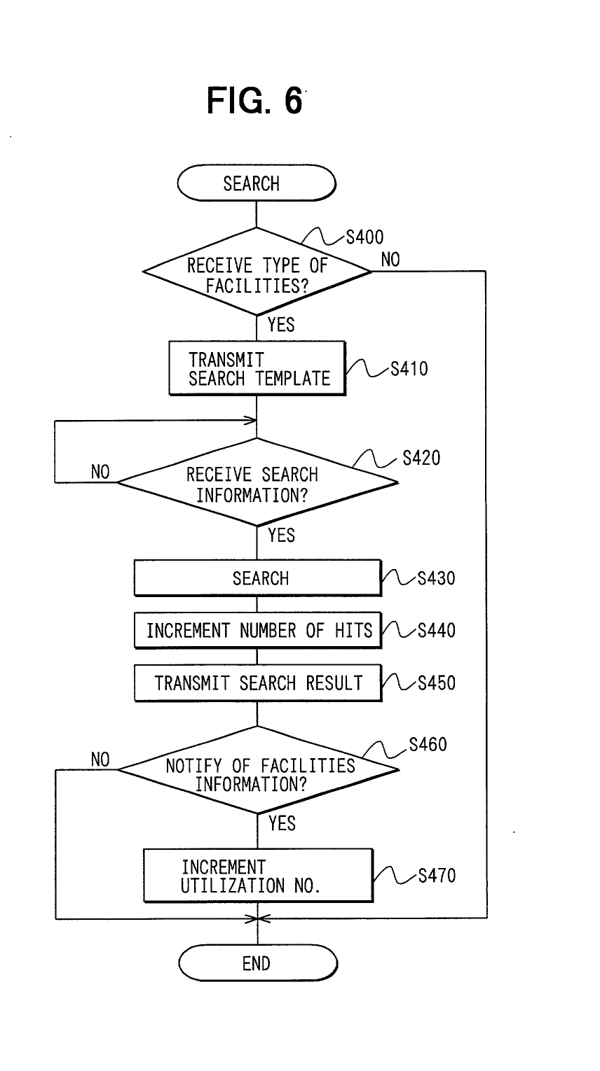

To match this search request processing, the data processor 40 of the management center 4 conducts a search. This search processing is described with reference to FIG. 6. This search processing is repeatedly executed once a data communication enable state is established with the car navigation system 2. First, at S400, whether any facility type has been received is determined. This matches S300 in FIG. 5. If any facility type has been received (S400: YES), the process moves to S410. If no facility type has been received (S400: NO), the search processing is ended. At S410, a search template matching the received facility type is transmitted. In response, the car navigation system 2 transmits sought information entered based on this search template (S320 in FIG. 5). Therefore, at S420, whether the sought information has been received is determined. If the sought information has not been received (S420: NO), this determination processing is repeated. If the sought information has been received (S420: YES), the process goes ahead to S430.

At S430, using the received sought information, the facility information stored in the facility information storage 52 are searched for any unit of facility information meeting the search conditions. If the entered sought information does not cover all the search headings as mentioned above, a search is executed based on the sought information that has been entered and transmitted.

At S440 that follows, the number of hits matching the unit of facility information that meets the search conditions (that has been hit) is incremented. The number of hits represents the number of times the unit of facility information has met the search conditions. This is stored into the history storage 53 as stated above. Then, at the next S450, the unit of facility information as the search result is transmitted to the car navigation system 2. In response, the car navigation system 2, if the unit of facility information as the search result is utilized for setting the destination or a point en route (S 350 in FIG. 5: YES), notifies that utilized unit of facility information (S360). Therefore, at S460, it is determined whether the unit of facility information has been notified. Here, an affirmative determination is made of whether the unit facility information is notified within a prescribed length of time, which may be three minutes for instance. If it is determined there that the unit of facility information has been notified (S460: YES), the frequency of utilization matching the notified unit of facility information is incremented (S470), and after that this search processing is completed. The frequency of utilization represents the number of times the unit of facility information has been utilized for setting a destination or a point en route, and is stored into the history storage 53 as described above. If the unit of facility information has not been notified (S460: NO), this search processing is ended without executing the processing of S470.

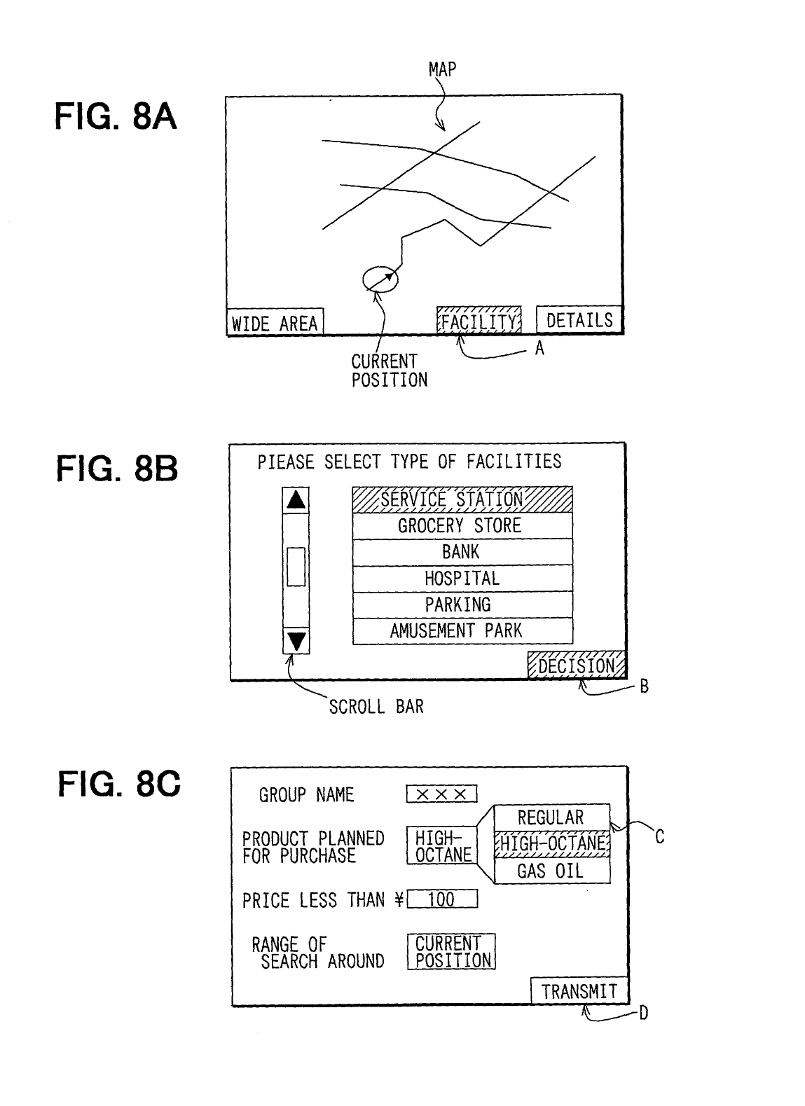

This process will now be more specifically described in operation with the car navigation system 2. FIG. 8A shows, together with a map, how the current position of the car is displayed on that map. In the lower part of the screen, a “facility” button indicated by sign A is displayed. When this “facility” is pressed, a screen requesting selection of a facility type emerges as shown in FIG. 8(b). Incidentally, pressing the “facility” button means (where the operating switch group 32 consists of touch switches integrated with the display device 35) touching the pertinent part of the screen with a finger. Alternatively, the pointer on the screen may as well be moved to make a deciding operation on the “facility” button image. A mechanical operating switch group 32 can also be used, or a remote control terminal 37a via the remote control sensor 37 can be used. In the following description, any reference to a selecting operation or pressing a button indicates any of these or other known operations.

The screen shown in FIG. 8B displays a list of facility types. Any information that overflows the screen is displayed by using the scroll bar. The user places the facility type desired to be searched in a selected state (service stations are in a selected state in the illustration), and selects the facility type by pressing the decision button indicated by sign B. The selected facility type is transmitted to the management center 4 (S300 in FIG. 5).

Then, as the search template for service stations (see FIG. 7B) is transmitted from the management center 4 (S410 in FIG. 6), the user is required to enter search information based on this search template (S310 in FIG. 5) when the screen is as illustrated in FIG. 8C. The group name is among the search headings because there may be circumstance where a customer paying by credit card or by any specific means is entitled to a discount at a service station affiliated with such and such oil company. Entry of this group name is heading 1) in the search template. Also the name of a product planned for purchase can be entered, and the desired price of that product can also be entered. These are 2), and 3), respectively, in the search template. The range of search can be designated, too, which is 4).

In this embodiment, the area around the current location is the default search range. However, when route guidance is under way in a navigator function, any set destination or point en route can be selected as well. It is also conceivable to set a radius of 3 km, for instance, as the default value of the surrounding area. It is also conceivable to designate the area as a radius of xx km.

A group name, a product planned for purchase or a range of search can be entered by selecting desired aspects out of a plurality of available options. For instance, the name of a product planned for purchase can be entered by selecting one out of the window of options indicated by sign C in FIG. 8C. FIG. 8C illustrates selection of gasoline (premium). For the price, it is conceivable to selectively enter preferred aspects out of numerals “0” through “9” that are displayed. It is also conceivable to choose one preset candidate, such as \90, \100, \110 and so forth. The greater the number of input items, the more desirable as the procedure of entering sought information is simplified.

Whereas pieces of information entered in this manner constitute sought information, not all entered items of information need be actually entered in this embodiment as mentioned earlier. For instance, only the group name, product planned for purchase and its desired price, range of search, or any combination of these items can be entered.

When the “transmit” button indicated by sign D in FIG. 8C is pressed where search information has already been entered, the car navigation system 2 transmits the entered sought information to the management center 4 (S320 in FIG. 5). This causes the management center 4 to search its store of facility information according to the sought information (S430 in FIG. 6), and transmits the search result to the car navigation system 2 (S450).

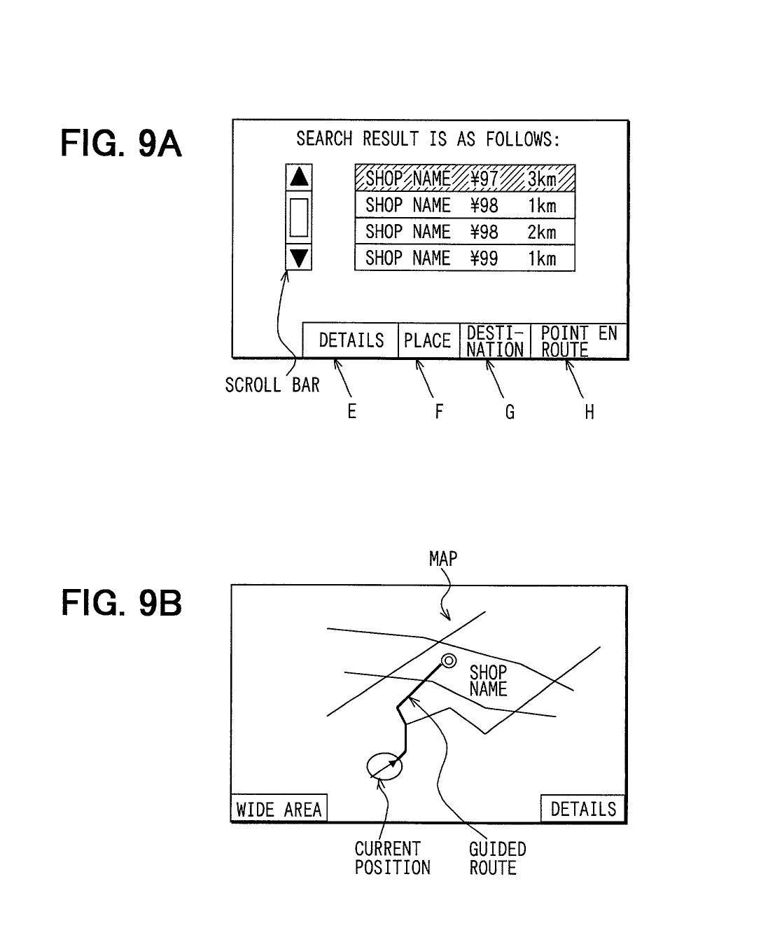

The car navigation system 2 displays this facility information as a search result (S340 in FIG. 5) as illustrated in FIG. 9A. This example is a case in which the names of the retrieved service station, the price of the product planned for purchase at each service station, and the distance to each service station is provided. If one of these search results is placed in a selected state (the service station ** is in a selected stated in the illustration) and the “details” button indicated by sign E is pressed, more detailed information can be referenced. These details match headings 6) and 7) in the registration template shown in FIG. 7A. As the “location” button indicated by sign F is pressed, the location of the facility on the map is displayed. Since locational information as an item of facility information is stored in association with map data, the car navigation system 2 can readily display the location of the facility on a map. Further, if the “destination” button indicated by sign G or the “point en route” button indicated by sign H is pressed, the facility in a selected state is set as the destination or a point en route, respectively, of route guidance. If, for instance, it is set as the destination, a guided route to that destination is displayed on the map, and route guidance using the speech output device 36 is started as illustrated in FIG. 9B.

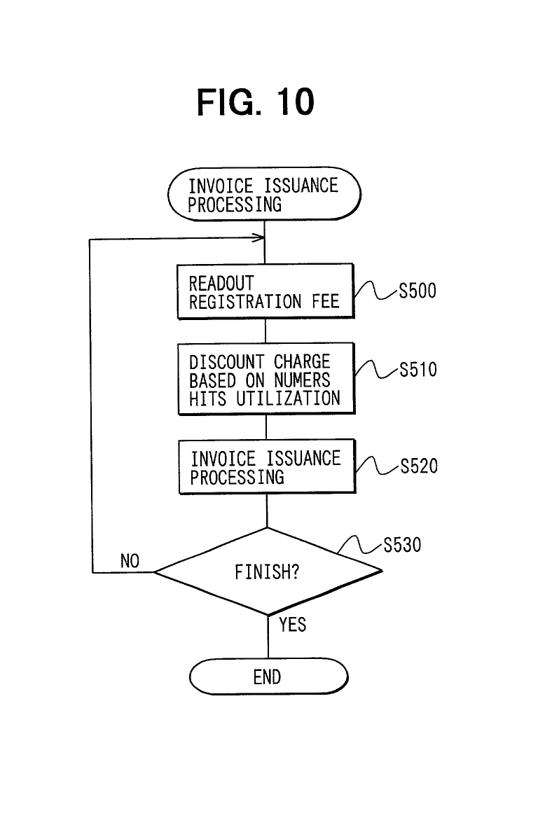

Incidentally, as described with reference to FIG. 4, the management center 4 stores facility information from the registration terminal 6 (S250), and then calculates and stores the registration fee (S260). Such registration fees are stored separately for each information provider, and the system manger monthly issues an invoice for the registration fees to each information provider. For this purpose, the data processor 40 executes an invoice issuance process as shown in FIG. 10 every month. Now, this invoice issuance processing will be described with reference to the flow chart of FIG. 10.

First at S500, stored registration fees are read out. At the next step S510, the number of hits and frequency of utilization are read from the history storage 53, and the charge is discounted according to these number of hits and frequency of utilization. For instance, if the number of hits and the frequency of utilization are above respective prescribed levels, the total sum is discounted by 20%. Then, at the next step S520, invoice issuance processing is executed. This processing involves printing of invoices and accordingly supply of data to a printer unit (not shown). Then at S530 that follows, whether all the information providers have been billed is determined. If all the information providers have been billed (S530: YES), the invoice issuance process is completed. If any information provider has not yet been billed (S540: NO), the process from S500 is repeated.

Next, the effects of this registration/search system 1 embodying the present invention are described. The registration/search system 1 uses registration templates to reduce inconsistencies among facility information patterns registered by information providers. This enables sufficient but not excessive facility information including incidental information which would be convenient for later search. It further uses search templates to enable information matching registration headings to be entered as sought information.

The registration/search templates, available in different contents according to facility type, are stored in the template storage 51 of the management center 4, and transmitted from the management center 4 (S230 in FIG. 4, S410 in FIG. 6). In the registration/search templates, registration/search headings matching one type of facility or another are stated (see FIG. 7). This feature facilitates the registration/search operations and, moreover, makes possible search according to miscellaneous items of information which previously could not serve as search keys (incidental information). Furthermore, as the registration/search templates are transmitted from the management center 4, any increase in the variety of facility types can be readily addressed.

Entry of sought information based on the search template can be limited to information matching only some of the search headings. As a result, facilities can be searched according to only one item of information or the search can be narrowed by using a plurality of items, and incidental information can be used to enhance the search as well.

For users, abundant availability of types of information which do not meet the search conditions would make no sense and, even if available types of information meet the search conditions, the purpose of promoting the use of the facility covered by the information can be fulfilled unless the available information is actually utilized.

In view of these points, in this registration/search system 1, the number of hits and the frequency of utilization for each stored unit of facility information stored in the facility information storage 52 of the management center 4 are stored into the history storage 53. Therefore, the number of hits and the frequency of utilization stored in the history storage 53 can be presented to information providers. This presentation of information is highly likely to help the information providers supply users with information they desire to have. As a result, information supplied by information providers can better meet the expectations of users.

Further, in the registration/search system 1, registration processing executed by the management center 4 is given a configuration involving calculation and storage of registration fees (S260 in FIG. 4) to bill information providers for their registrations (S520 in FIG. 10). By using the revenue of such registration fees to pay, for example, the costs of operating and maintaining the system or the costs to car navigation systems 2 of communicating with the management center 4, it will be an extra advantage to users, who might then be allowed to search facility information free of charge, and enable the system to attract many more users.

This embodiment of the invention, discounts registration fees according to the number of hits and the frequency of utilization (S510 in FIG. 10). This motivates information providers to supply information desired by users, resulting in more facility information of high quality.

The registration terminal 6 of this registration/search system 1, using map data transmitted from the management center 4, enables facility locational information to be entered in association with the map data (S130 in FIG. 3). This enables the car navigation system 2 to use locational information on the identified facility to display the location of the facility on the map more easily.

Further, the registration/search system 1 can have a search request issued by the car navigation system 2, and expand the search range, instead of being limited to vicinities of the current location. It can include vicinities of the destination and points en route if they are set. Therefore, in this respect as well, entry of the search conditions is simplified. Since, conversely, it is also possible to set the destination and points en rout by utilizing retrieved facility information, it would be more convenient for users.

The control unit 10 of the car navigation system 2 preferably corresponds to a “sought information input unit”. The control unit 10 and the communication device 33 together correspond to a “sought information transmitter”. The control unit 10 and the display device 35 together correspond to a “notifying unit”. Processing at S310 in FIG. 5 corresponds to processing by the sought information input unit; that at S320, to processing by the sought information transmitter; and that at S340, to processing by the notifying unit. Further, the data processor 40 of the management center 4 preferably corresponds to a “search unit”. The data processor 40 and communication unit 54 together correspond to a “sought facility information transmitter”. The facility information storage 52 corresponds to a “facility information storage unit”, and the history storage 53 corresponds to a “search frequency storage unit” and a “utilization frequency storage unit” combined. Further, processing at S430 in FIG. 6 corresponds to processing by the search unit, and processing at S450, to processing by the sought facility information transmitter.

In addition, the control unit 60 of the registration terminal 6 corresponds to a “facility information input unit”, and the control unit 60 and the communication device 71 together correspond to a “registrable facility information transmitter”. Processing at S130 in FIG. 3 corresponds to processing by the facility information input unit, and processing at S150, to processing by the registrable facility information transmitter.

The present invention is in no way limited by these features of the above-described embodiment therefore, but can be implemented in various other modes without deviating from the true spirit thereof.

(a) The registration terminal 6 of the registration/search system 1 associates facility locational information with map data. Therefore, where facility information is updated, this association with map data can be utilized to identify the facility information to be updated. In more specific terms, update processing is as follows. First, the registration terminal 6 makes an updating request in place of the registration request at S100 FIG. 3, and map data with which local information is associated, instead of a facilities list, is transmitted from the management center 4. The registration terminal 6 displays a map based on the map data instead of S120, and displays the facility locations overlapping the map. The information provider concerned is required to choose from the facility locations displayed on this map, and is enabled to identify on the map the facility the information to be updated.

Incidentally, though only facility locational information is associated with map data in the foregoing embodiment, all facility information can be stored in association with map data.

(b) While the registration/search system 1 supplies facility information by using the car navigation system 2, a system can supply information using a mobile apparatus such as a handy phone or a laptop or handheld unit. Information may also be supplied from a desktop personal computer. If these apparatuses are used in combination, some users may use handy phones while others may use a car navigation system 2 to access the management center 4.

While the above-described embodiments refer to examples of usage of the present invention, it is understood that the present invention may be applied to other usage, modifications and variations of the same, and is not limited to the disclosure provided herein.

What is claimed is:

1. A facility information registration and search system comprising:
a management center for storing and managing facility information of different facility types;
a registration terminal for enabling an information provider to register facility information; and
a search terminal for providing the facility information to a user;
wherein the registration terminal is provided with:
a facility information input unit for enabling the information provider to enter facility information corresponding to registration headings based on a registration template, the registration template having predetermined registration headings; and
a registrable facility information transmitter that transmits facility information entered by the facility information input unit to the management center;
wherein the search terminal is provided with:
a sought information input unit for enabling a user to enter sought information corresponding to search headings in a search template, said search headings matching the registration headings;
a sought information transmitter for transmitting sought information entered by the sought information input unit to the management center; and
a notifying unit for outputting a facility information search result transmitted by the management center in response to transmission of sought information by the sought information transmitter;
wherein the management center is provided with:
a facility information storage unit for storing the facility information transmitted from the registration terminal;
a search unit for searching the facility information stored in the facility information storage unit with the sought information transmitted from the search terminal; and
a sought facility information transmitter for transmitting the facility information search result retrieved by the search unit to the search terminal.

2. The facility information registration and search system according to claim 1, wherein the registration template and search template are available in varieties differing with a facility type.

3. The facility information registration and search system according to claim 1, wherein the registration template and the search template are transmitted from the management center.

4. The facility information registration and search system according to claim 1, wherein the sought information input unit permits omission of sought information for some of the search headings stated in the search template; and
the search unit of the management center performs search based on non-omitted sought information.

5. The facility information registration and search system, according to claim 1, wherein:
the management center has a search frequency storage unit for storing a number of hits according to a search, the number of hits stored separately for each item of facility information, and
the management center stores and updates the number of hits into the search frequency storage unit based on a search result by the search unit.

6. The facility information registration and search system, according to claim 1, wherein:
the management center has a search frequency storage unit for storing a frequency of utilization, the frequency of utilization representing a number of times the facility information has been utilized separately for each item of facility information;
the search terminal has a utilization frequency storage function to notify the management center of utilized facility information and for the management center to update the frequency of utilization when a facility information search result is utilized by the user when the utilized facility information search result is output from the search terminal, the search terminal storing the frequency of utilization into the utilization frequency storage unit.

7. The facility information registration and search system, according to claim 1, wherein the management center calculates a fee for registration in storing the facility information from the registration terminal.

8. The facility information registration and search system according to claim 7, wherein:
either a number of hits or a frequency of utilization is recorded in the frequency storage unit;
a registration fee is discounted based on either the number of hits stored in the search frequency storage unit or the frequency of utilization stored in the utilization frequency storage unit.

9. The facility information registration and search system according to claim 1, wherein:
a registrable information input unit of the registration terminal enters at least locational information as facility information in association with map data by displaying a map and enabling a map location to be selected.

10. The facility information registration and search system according to claim 9, wherein map data displayed by the registrable information input unit of the registration terminal is transmitted from the management center.

11. The facility information registration and search system, according to claim 1, wherein the search terminal is a car navigation system having a route guidance function.

12. The facility information registration and search system according to claim 11, wherein:
the search terminal transmits at least one of a current location, destination, points en route and guide route to the management center as sought information or part of sought information, the guide rout being a route to a destination;
the search unit searching the facility information with reference to areas around the current location, destination, points en route and guided route, transmitted from the search terminal as ranges of search.

13. The facility information registration and search system according to claim 11, wherein the search terminal sets a destination or points en route based on the facility information search result transmitted from the management center.

14. The facility information registration and search system according to claim 11, wherein the search terminal notifies the management center when a destination or point en route is set based on the facility information, the search terminal notifying the management center that the facility information has been utilized.

15. A management center comprising:
a facility information registration and search system with a registration terminal for enabling an information provider to register facility information for various facility types;
a search terminal for notifying a user of the facility information;
a management center storing and managing the facility information;
wherein the registration terminal is provided with a facility information input unit for enabling an information provider to enter information corresponding to the registration headings as the facility information based on a registration template in which predetermined registration headings are stated;
wherein the registration terminal includes a registrable facility information transmitter for transmitting facility information entered by the facility information input unit to the management center; and
wherein the search terminal is provided with a sought information input unit for enabling the user to enter sought information corresponding to search headings for searching according to the registration headings based on a search template in which predetermined search headings matching the registration headings are stated;
a sought information transmitter for transmitting sought information entered by the sought information input unit to the management center;
a notifying unit for notifying facility information as the search result transmitted by the management center in response to the transmission of the sought information by the sought information transmitter;
wherein the management center further includes:
a facility information storage unit for storing the facility information transmitted from the registration terminal;
a search unit for searching the facility information stored in the facility information storage unit by using the sought information transmitted from the search terminal; and
a sought facility information transmitter for transmitting to the search terminal facility information as the search result retrieved by the search unit.

16. A registration terminal including a facility information registration and search system together with a management center for storing and managing facility information regarding various facility types, said registration terminal comprising:
a sought information transmitter for transmitting sought information entered by the sought information input unit to the management center;
a notifying unit for notifying facility information as the search result transmitted by the management center in response to the transmission of the sought information by the sought information transmitter; and
wherein the management center includes:
a facility information storage unit for storing the facility information transmitted from the registration terminal;
a search unit for searching the facility information stored in the facility information storage unit by using the sought information transmitted from the search terminal;
a sought facility information transmitter for transmitting to the search terminal facility information as the search result retrieved by the search unit;
wherein the registration terminal further includes a facility information input unit for enabling the information provider to enter, information corresponding to the registration headings as the facility information based on a registration template in which registration headings are stated; and
a registrable facility information transmitter for transmitting the facility information entered by the facility information input unit to the management center.

17. A registration terminal including a facility information registration and search system together with a management center for storing and managing facility information regarding various facility types, the registration terminal comprising:
a facility information input unit for enabling the information provider to enter information corresponding to the registration headings as the facility information based on a registration template in which predetermined registration headings are stated;
a registrable facility information transmitter for transmitting the facility information entered by the facility information input unit to the management center; and
wherein the management center is provided with:
a facility information storage unit for storing facility information transmitted from the registration terminal;
a search unit for searching the facility information stored in the facility information storage unit by using the sought information transmitted from the search terminal; and
a sought facility information transmitter for transmitting to the search terminal facility information as the search result retrieved by the search unit;
wherein the search terminal further includes:
a sought information input unit for enabling an user to enter sought information corresponding to the search headings for searching according to the registration headings based on a search template in which predetermined search headings matching the registration headings are stated;
a sought information transmitter for transmitting the sought information entered by the sought information input unit to the management center; and
a notifying unit for notifying, in response to the transmission of the sought information by the sought information transmitter, facility information as the search result transmitted by the management center.

18. A facility information registration and search system, comprising:
a management center that stores and manages facility information;
a registration terminal interfacing with a registration user through a registration template, said registration template having predetermined registration headings, facility information being transmitted from said registration terminal according to said registration template to said management center; and
a search terminal interfacing with a search user through a search template, said search template having search headings, said search template and said search headings matching said registration template and said registration headings, said search terminal uploading sought information according to search headings and said search template to said management center;
wherein said management center searches said facility information based on said search information and provides a search result to said user.

19. The facility information registration and search system according to claim 18, wherein the registration template and the search template are created at the management center and distributed from the management center to the search terminal and registration terminal respectively.

20. The facility information registration and search system, according to claim 1, wherein the management center stores a number of hits generated by the management center when searching said facility information.

21. A method for searching facility information comprising:
obtaining facility information through a plurality of registration headings on a registration template of a registration terminal;
transmitting said facility information to a management center;
obtaining sought information through a plurality of search headings on a search template of a search terminal, said search headings and said search template matching respective said registration headings and said registration template;
transmitting said sought information to said management center;
searching said facility information according to said sought information at said management center; and
outputting a search result from said management center.
